(19) United States
(12) Patent Application Publication
(10) Pub. No.: US 2023/0154351 A1
(43) Pub. Date: May 18, 2023

(54) SYSTEM AND METHOD OF ADJUSTING FOCAL DISTANCES OF IMAGES DISPLAYED TO A USER OF A SIMULATOR

(71) Applicant: FLIGHTSAFETY INTERNATIONAL INC., Melville, NY (US)

(72) Inventor: Justin K. Knaplund, The Hills, TX (US)

(73) Assignee: FLIGHTSAFETY INTERNATIONAL INC., Melville, NY (US)

(21) Appl. No.: 17/987,295

(22) Filed: Nov. 15, 2022

Related U.S. Application Data
(60) Provisional application No. 63/279,566, filed on Nov. 15, 2021.

(51) Int. Cl. G09B 9/32; G09B 9/24; G09B 9/46

(52) U.S. Cl. CPC G09B 9/326; G09B 9/323; G09B 9/24; G09B 9/46

(57) ABSTRACT

Systems and methods for adjusting focal distances of images displayed to a user at a designated eye point of a simulator are provided. An image may be generated for display by a screen, wherein the image is reflected by a mirror to the designated eye point. A simulated distance from the designated eye point to an object in the image may be determined. A focal distance for the image may be determined based on the simulated distance. A simulated size of the object may be determined based on the simulated distance. An adjustor may alter a distance between the screen and the mirror to achieve the focal distance. A size of the object may be adjusted in the image based on the simulated size.

### CROSS-REFERENCE TO RELATED APPLICATIONS

This application claims priority under 35 U.S.C. § 119(e) to U.S. Provisional Patent Application Ser. No. 63/279,566 filed Nov. 15, 2021, which is incorporated herein in its entirety by reference.

### FIELD

The present disclosure is related generally to adjusting focal distances of images displayed to a user at a designated eye point of a simulator. More particularly, the present disclosure provides systems and methods to adjust a distance between a screen and a mirror of the simulator based on a simulated distance between a designated eye point and an object in an image displayed by the screen and reflected by the mirror. An adjustor is provided to adjust the distance between the screen and the mirror.

### BACKGROUND

An advanced simulator to train a user to operate a vehicle (such as a flight simulator) typically has a primary display to provide an image to the user depicting an environment surrounding the vehicle. Referring to FIG. 1, the realism of the image 12 of the primary display 4 is achieved by collimating the light (and thus, the image) to the user 30, which renders the image at infinity focus. For example, the image may have a focus length of greater than approximately 30 feet. A projector 6 projects the image 12 onto a screen 8 and the image is viewed by the user 30 (such as a pilot) as a reflection in a mirror array 10. As shown in FIG. 1, the image 12 of the primary display 4 is visible to the user as indicated by a first arrow 34 as collimated light rays 14 and seen at a distant focus. The collimated light rays 14 are substantially parallel to each other.

Some vehicles, including an aircraft such as a helicopter, may have a window referred to as a “chin” window positioned to provide a downward view from the aircraft as indicated in FIG. 1 by a second arrow 36. The chin window may be near the floor of a cabin or cockpit of the aircraft. In some aircraft, the chin window is positioned in front of rudder pedals of the aircraft. A pilot may use the chin window to see a reference point or object (such as the ground) during take-off, landing, and while the aircraft is hovering.

Some prior art simulators 2 include a chin display 20 to replicate objects 16B which would be seen outside the cockpit through a chin window 18. Known simulators typically use either a real image display system or a wide angle collimated (WAC) display system to display images visible through the chin window.

The real image display system 20 uses a monitor or a rear projection screen 22 placed in front of the chin window 18 of the simulator. The pilot or user 30 of the simulator views the image 24 of the real image display system through the chin window 18. The simulated image 24 created by the real image display system has a view distance of between about 6 feet to about 8 feet. The view distance is equal to the physical distance between the designated eye point 32 of the simulator 2 and the monitor or screen 22 of the real image display system 20. As will be appreciated by one of skill in the art, the designated eye point 32 represents a preferred or optimal position of an eye of the user 30 when in the simulator. The designated eye point is used when designing components of the simulator to provide an optimal view of images created by the simulator for viewing by the user.

The real image display system 20 provides realistic depth cues when the simulator provides a simulation of flying below a simulated height 28 of about 10 feet above the simulated ground 26. The real image display system also provides a bright and sharp image with a relatively wide field of view (FOV). However, there are several disadvantages with known real image display systems 20, including that they are not compatible with Night Vision Goggles (NVGs) when those NVGs are focused to be compatible with the near-infinity focus of the primary display 4. As will be appreciated, this precludes the use of the simulator to provide training for certain activities and for some simulated conditions (such as night flying operations) negatively limiting the training possible with the prior art simulator 2.

Moreover, as generally illustrated in FIG. 1, an object 16B in the image 24 produced by the real image display system 20 for viewing through the chin window 18 will become misaligned with an object 16A in the collimated image 12 of the primary display 4 when the user's head moves. This problem is generally illustrated in FIG. 1 in which an upper portion of a tree 16A displayed in the image of the primary display 4 is offset horizontally from a lower portion of the same tree 16B displayed in the image 24 generated by the real image display system 20.

Also, because the real image display system has a fixed focal distance and the primary display is at infinity focus, the user's eyes must adjust to the different focal lengths as the user looks out the chin window (as indicated by the second arrow 36) and then looks out the main window (as shown by the first arrow 34). The change in focus negatively impacts the realism of the simulator, causes discomfort to the user, and results in eye fatigue. Known real image display systems also provide unrealistic depth cues when the simulated aircraft has a simulated height 28 of greater than about 10 feet above the simulated ground 26.

A WAC display system used as a chin display provides some benefits compared to a real image display system. For example, an image provided by a WAC display system is at an infinity focus. When viewed through a chin window of a simulator, the image provided by the WAC display system will stay aligned with the image 12 of the primary display 4 even during movement of the user's head. WAC display systems are compatible with NVGs, and a WAC display system can provide realistic depth cues when the simulated aircraft has a simulated height of greater than about 15 feet above the simulated ground. However, the image provided by the WAC display system will have unrealistic depth cues when the simulated height is less than about 10 feet. Another problem with known WAC display systems is that they have a relatively small FOV of less than about 25° in a horizontal dimension and 15° vertical in a vertical dimension. Other problems of WAC display systems for chin windows are limited brightness and that they are more expensive than real image display systems 20.

A significant disadvantage of both types of prior art chin window displays is that they have a fixed focal distance which can only be optimized for one viewing distance. For example, in a simulation of an aircraft descending from a high hover (such as at a simulated height 28 of approximately 30 feet) to touchdown, a real image display system with a viewing distance of approximately 6 feet to 8 feet is unrealistic for the first 90% of the descent. Similarly, a WAC display system for a chin window is unrealistic for the final portion of the descent from about 30 feet to touchdown. Accordingly, conventional chin displays are inaccurate during significant portions of simulated landing or take-off procedures. The visual errors described for the real image display systems and the WAC display system can result in the user misjudging descent rate and height above terrain using either type of display, resulting in hard landings and difficulty maintaining a hover position. These deficiencies result in significant limitations in the realism and usefulness of prior art simulators.

Accordingly, there is a need for systems and methods for adjusting focal distances of images of a simulator in real-time.

### SUMMARY

It is one aspect of the present disclosure to provide a system to adjust focal distances of images displayed to a user at a designated eye point. The system comprises: (1) a screen configured to display an image depicting an object; (2) a mirror configured to reflect the image displayed by the screen to the designated eye point, the mirror spaced from the screen by a distance that is variable; and (3) an adjustor configured to adjust the distance between the screen and the mirror.

In some embodiments, the system further comprises a control system in communication with the adjustor, the control system configured to: (a) determine a focal distance for the image based on a simulated distance between the designated eye point and the object in the image; (b) determine a simulated size of the object based on the simulated distance; (c) generate instructions to cause the adjustor to adjust the distance between the screen and the mirror to achieve the focal distance; and (d) adjust a size of the object in the image based on the determined simulated size.

The system may include any one or more of the previous embodiments and optionally the control system is further configured to: (1) generate the image; and (2) determine a simulated size of the object.

In some embodiments, the screen is at least one of a liquid-crystal display, an organic light-emitting diode display, a liquid crystal on silicon display, a light-emitting diode display, a quantum dot display, and a plasma display.

The system may optionally include one or more of the previous embodiments and, in some embodiments, the system may further comprise a projector configured to project the image onto the screen, the screen being one of a front projection screen and a back projection screen.

In embodiments in which the screen is a back projection screen, the projector is positioned to project the image onto a rear surface of the screen, and a front surface of the screen is oriented toward the mirror. In this embodiment, the back projection screen may be positioned at least partially between the mirror and the projector.

Alternatively, when the screen is a front projection screen, the projector is positioned to project the image onto the front surface of the screen, and the front surface of the screen is oriented toward the mirror. In this embodiment, the projector may be positioned at least partially between the mirror and the front projection screen.

In one or more embodiments, the front surface of the screen facing the mirror is convex.

Optionally, the front surface of the screen has a shape that includes at least a section of a circle, a sphere, a parabolic, an ellipsoid, a plane, a freeform, and combinations thereof.

In some embodiments, the projector is a fixed distance from the screen, and the adjustor is configured to move the screen and the projector.

In some embodiments, the adjustor comprises a motor for moving at least one of the screen and the mirror to adjust the distance.

In other embodiments, the mirror is stationary. Optionally, the mirror is a fixed distance from the designated eye point.

The system may include one or more of the previous embodiments and optionally the screen is interconnected to a platform of the adjustor, the platform being movable.

The system may include any one or more of the previous embodiments and optionally the platform is configured to move to adjust the distance between the screen and the mirror.

In some embodiments, the adjustor comprises a stop to prevent the screen from contacting the mirror.

In some embodiments, the distance from the screen to the mirror correlates to the focal distance.

In some embodiments, the screen has a first position at which the screen is a first distance from the mirror and the focal distance is at infinity.

Optionally, in the first position, light rays reflected from the mirror are substantially parallel.

In a second position the screen is a second distance from the mirror and the focal distance is less than infinity. The first distance is greater than the second distance.

In some embodiments, the system includes one or more of the previous features and optionally the mirror has a front surface that is reflective and which is oriented toward the designated eye point and the screen. The front surface of the mirror has a shape configured collimate light from the screen when the screen is a predetermined distance from the mirror.

The front surface of the mirror optionally is concave.

Optionally, the front surface of the mirror has a shape that is adjustable.

Optionally, the front surface of the mirror has a shape that includes at least a section of a circle, a sphere, a parabolic, an ellipsoid, a plane, a freeform, and combinations thereof.

The system may include any one or more of the previous embodiments and optionally the system is associated with a simulator, such as a flight simulator.

In some embodiments, the simulator is an aircraft simulator and includes a chin window positioned between the designated eye point and the mirror.

In at least one embodiment, the image displayed by the screen is visible to the user through the chin window.

It is another aspect of the present disclosure to provide a control system for a simulator to adjust focal distances of images displayed to a user at a designated eye point of the simulator. The control system may comprise: (1) a processor; and (2) a memory storing instructions for execution by the processor that, when executed, cause the processor to: (a) generate an image for display by a screen, the screen positioned and oriented such that the image may be reflected by a mirror to the designated eye point; (b) determine a simulated distance from the designated eye point to an object in the image; (c) determine a focal distance for the image based on the simulated distance; (d) determine a simulated size of the object based on the simulated distance; (e) generate instructions to cause an adjustor to adjust a distance between the screen and the mirror to achieve the focal distance; and (f) adjust a size of the object in the image based on the determined simulated size.

Optionally, determining the simulated distance comprises one or more of: (1) receiving a position of the designated eye point; (2) determining a simulated position of the object relative to the designated eye point; and (3) determining a distance between the position of the designated eye point and the simulated position of the object.

In some embodiments the control system includes one or more of the previous embodiments and the distance from the screen to the mirror correlates to the focal distance.

In a first position, the screen is a first distance from the mirror and the focal distance is at infinity. In a second position, the screen is a second distance from the mirror and the focal distance is less than infinity. The first distance is greater than the second distance.

The control system may include any one or more of the previous embodiments and optionally the memory includes an instruction to keep the screen at the first position that is the first distance from the mirror when the simulated distance is greater than a predetermined threshold. In some instances, the predetermined threshold is about thirty feet. In other embodiments, the predetermined threshold is greater or less than thirty feet.

The control system may include one or more of the previous embodiments and may further comprise an instruction to move the screen to the second position that is the second distance from the mirror when the simulated distance is less than the predetermined threshold.

In some embodiments the simulator is configured to simulate an aircraft. The simulator may optionally include a chin window positioned between the designated eye point and the mirror such that the image displayed by the screen is visible to the user through the chin window.

It is another aspect of the present disclosure to provide a method for adjusting focal distances of images at a designated eye point, comprising: (1) generating an image for display by a screen, the screen being oriented such that the image is reflected by a mirror of the simulator to the designated eye point; (2) determining a simulated distance between the designated eye point and a simulated position of an object in the image; (3) determining a focal distance for the image based on the simulated distance; (4) determining a simulated size of the object based on the simulated distance; (5) generating an instruction to cause an adjustor to alter a distance between the screen and the mirror to achieve the focal distance; and (6) adjusting a size of the object in the image based on the simulated size.

Optionally, the method may further comprise receiving a position of the designated eye point.

In some embodiments, the screen and the mirror are associated with a simulator configured to simulate an aircraft.

The simulator optionally includes a chin window positioned between the designated eye point and the mirror.

In some embodiments, the image displayed by the screen is visible to a user through the chin window.

The method may include one or more of the previous embodiments and may further comprise maintaining the screen at a first position that is a first distance from the mirror when the simulated distance is greater than a predetermined threshold. In the first position, light rays reflected from the mirror are substantially parallel such that the focal distance of the image is at infinity.

In some instances, the predetermined threshold is about thirty feet. In other embodiments, the predetermined threshold is greater or less than thirty feet.

In some embodiments the method further comprises moving the screen to a second position that is a second distance from the mirror when the simulated distance is less than the predetermined threshold. At the second position, light rays reflected from the mirror are not parallel and the image has a fixed focal distance that is less than infinity.

The method may comprise any one or more of the previous embodiments and optionally comprises moving the screen away from the mirror to the first position that is the first distance from the mirror when the simulated distance increases from less than the predetermined threshold to greater than the predetermined threshold.

Optionally, the method may further comprise moving the screen toward the mirror to the second position when the simulated distance decreases from greater than the predetermined threshold to less than the predetermined threshold.

Still another aspect is a flight simulator for training a student to operate an aircraft, comprising: (1) a primary display system to simulate a first view out of a window of the aircraft, comprising: (a) a projector; (b) a first screen, wherein the projector is operable to generate a first image that is displayed on the first screen; and (c) a mirror array to reflect the first image to a designated eye point of the simulator; and (2) a variable collimation display system to simulate a second view outside the aircraft visible through a chin window in a cabin of the simulator, the chin window positioned near a floor of the cabin, the variable collimation display system comprising: (i) a second screen to display a second image; (ii) a mirror to reflect the second image from the second screen through the chin window and to the designated eye point; and (iii) an adjustor configured to move the second screen relative to the mirror.

In some embodiments, when the second screen is a first distance from the mirror the second image is at infinity focus. Optionally, when the second screen is spaced the first distance from the mirror, light rays reflected from the mirror are substantially parallel.

In at least one embodiment, the front surface of the second screen facing the mirror has a shape that includes at least a section of a circle, a sphere, a parabolic, an ellipsoid, a plane, a freeform, and combinations thereof.

Optionally, when the second screen is a second distance from the mirror the second image has a fixed focal distance that is less than infinity, the second distance being less than the first distance.

The flight simulator may include one or more of the previous embodiments and optionally, the mirror is a fixed distance from the designated eye point.

In some embodiments, the second screen is at least one of a liquid-crystal display, an organic light-emitting diode display, a liquid crystal on silicon display, a light-emitting diode display, a quantum dot display, and a plasma display.

The flight simulator may optionally include one or more of the previous embodiments and, in some embodiments, the variable collimation display system may further comprise a second projector configured to project the second image onto the second screen, the second screen being one of a front projection screen and a back projection screen.

In embodiments in which the second screen is a back projection screen, the second projector is positioned to project the second image onto a rear surface of the second screen, and a front surface of the second screen is oriented toward the mirror. In this embodiment, the back projection screen is positioned at least partially between the mirror and the second projector.

Alternatively, when the second screen is a front projection screen, the second projector is positioned to project the second image onto the front surface of the second screen, and the front surface of the second screen is oriented toward the mirror. In this embodiment, the second projector is positioned at least partially between the mirror and the front projection screen.

In some embodiments, the second projector is a fixed distance from the second screen, and the adjustor is configured to move the second screen and the second projector.

In some embodiments, the adjustor comprises a motor to move at least one of the second screen and the mirror to adjust the distance between the second screen and the mirror.

In other embodiments, the mirror is stationary.

The flight simulator may include one or more of the previous embodiments and optionally the second screen is interconnected to a platform of the adjustor, the platform being movable.

The flight simulator may include any one or more of the previous embodiments and optionally the platform is configured to move to adjust the distance between the second screen and the mirror.

In some embodiments, the adjustor comprises a stop to prevent the second screen from contacting the mirror.

In some embodiments, the distance from the second screen to the mirror correlates to the focal distance.

In some embodiments, the flight simulator includes one or more of the previous features and optionally the mirror has a front surface that is reflective and which faces the designated eye point and the second screen. The front surface of the mirror has a shape configured collimate light from the second screen when the second screen is a predetermined distance from the mirror.

The front surface of the mirror optionally is concave.

In some embodiments, the front surface of the mirror has a shape that includes at least a section of a circle, a sphere, a parabolic, an ellipsoid, a plane, a freeform, and combinations thereof.

Optionally, the front surface of the mirror has a shape that is adjustable.

In some embodiments, the flight simulator includes one or more of the previous embodiments and further comprises a control system in communication with the adjustor.

Optionally, the control system is operatable to perform one or more of the following operations: (a) determine a focal distance for the second image based on a simulated distance between the designated eye point and an object in the second image; (b) determine a simulated size of the object based on the simulated distance; (c) generate instructions to cause the adjustor to adjust the distance between the second screen and the mirror to achieve the focal distance; and (d) adjust a size of the object in the second image based on the determined simulated size.

Optionally, the control system is further configured to generate the second image.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more clear from the Detailed Description, particularly when taken together with the drawings.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 5% of the stated value.

All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s).

FIG. 1 is a schematic side elevation view of a prior art simulator with a real image display system positioned outside of a chin window;

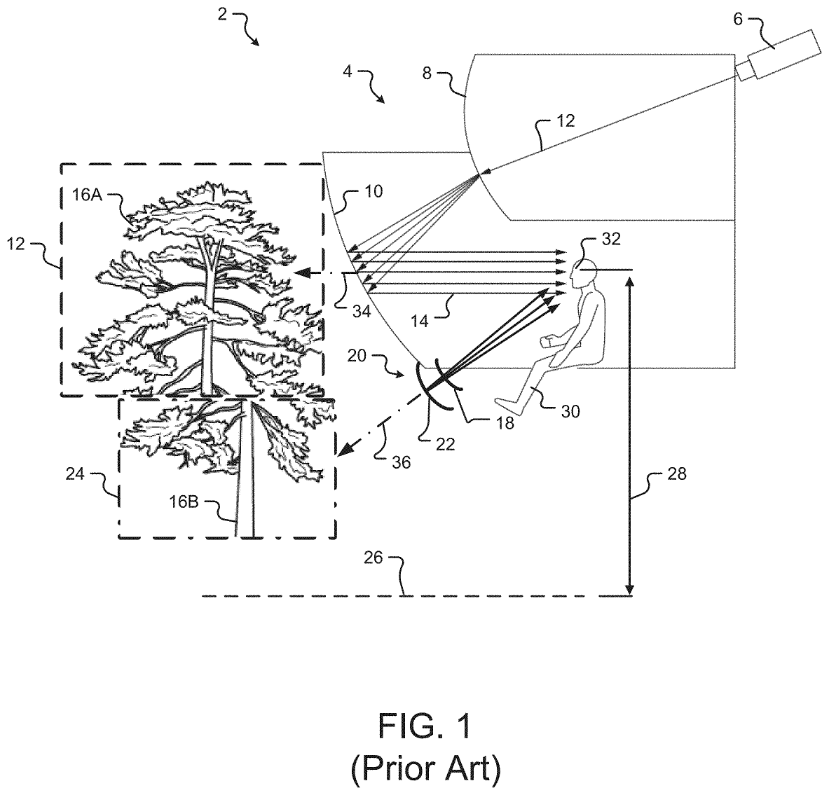

FIG. 2 is schematic side elevation view of a simulator with a variable collimation display system of embodiments of the present disclosure;

FIG. 3 is an isometric view of portions of the simulator of FIG. 2;

FIG. 4A is a schematic side elevation view of a variable collimation display system for a simulator according to embodiments of the present disclosure;

FIG. 4B is a schematic side elevation view of a variable collimation display system for a simulator according to other embodiments of the present disclosure;

FIG. 4C is a schematic side elevation view of a variable collimation display system for a simulator according to some embodiments of the present disclosure;

FIG. 5A is a schematic side elevation view of the simulator of FIG. 2 at a first simulated height above the ground;

FIG. 5B is another schematic side elevation view of the simulator of FIG. 2 at a second simulated height above the ground that is less than the first simulated height;

FIG. 6 is a schematic diagram of a control system of a system for adjusting a focal distance of an image according to embodiments of the present disclosure;

FIG. 7 is a flow chart illustrating a method of adjusting a focal distance of an image according to some embodiments of the present disclosure; and

FIG. 8 is another flow chart that generally illustrates a method for determining a simulated distance according to at least one embodiment of the present disclosure.

The drawings are not necessarily (but may be) to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

The following is a listing of components according to various embodiments of the present disclosure, and as shown in the drawings:

| Number | Component |
|---|---|
| 2 | Prior art simulator |
| 4 | Primary display |
| 6 | Projector |
| 8 | Screen |
| 10 | Mirror array |
| 12 | Image of primary display |
| 14 | Collimated light rays |
| 16 | Object in image |
| 18 | Chin window |
| 20 | Real image display system |
| 22 | Monitor or Screen of real image display system |
| 24 | Image of real image display system |
| 26 | Simulated ground |
| 28 | Simulated height above ground |
| 30 | User |
| 32 | Designated eye point |
| 34 | First arrow indicating direct of view at primary display |
| 36 | Second arrow indicating direction of view through chin |
| | window |
| 40 | Simulator |
| 42 | Cockpit |
| 44 | Window for the primary display |
| 45 | Upper window |
| 46 | Chin Window |
| 48 | Primary display |
| 50 | Projector of primary display |
| 52 | Screen |
| 54 | Mirror array |
| 56 | Image of primary display |
| 58 | Collimated light rays |
| 60 | Object in image |
| 62 | Variable collimation display system (or chin display, or |
| | variable display) |
| 64 | Image of variable collimation display system |
| 66 | Light Rays of variable collimation display system |
| 68 | Screen of variable collimation display system |
| 68A-1 | Rear or back projection screen |
| 68A-2 | Front projection screen |
| 68B | Self-illuminating screen |
| 70 | Rear Surface (of the Screen 68) |
| 72 | Front Surface (of the Screen 68) |
| 74 | Mirror of variable collimation display system |
| 76 | Rear Surface (of the Mirror 74) |
| 78 | Front Surface (of the Mirror 74) |
| 80 | Projector of variable collimation display system |
| 82 | Adjustor for variable collimation display system |
| 84 | Platform |
| 86 | Arrow indicating movement of platform |
| 88 | Stand for screen |
| 90 | Mount for projector |
| 92 | Actuator |
| 94 | Stop |
| 96 | Distance between mirror and screen |
| 96A | First distance |
| 96B | Second distance |
| 98 | Distance from projector to screen |
| 100 | Perceived (or simulated) distance between designated eye |
| | point and a simulated object |
| 102 | Height above terrain |
| 104 | Horizontal distance to the object |
| 106 | Simulated size or height of the object |
| 120 | Controller |
| 122 | Control System |
| 124 | Processor |
| 126 | Memory |
| 128 | Communication Interface |
| 130 | User Interface |
| 132 | Focal Distance Model |
| 134 | Size Model |
| 136 | Controller Instructions |
| 138 | Lookup table |
| 140 | Method |
| 142 | Generate image |
| 144 | Determine simulated distance to an object |
| 146 | Determine a focal distance |
| 148 | Determine simulated size of the object |
| 150 | Generate instructions for adjustor |
| 152 | Adjust simulated size of the object |
| 160 | Method |
| 162 | Receive position of the designated eye point |
| 164 | Determine simulated position of an object |
| 166 | Determine simulated distance |

### DETAILED DESCRIPTION

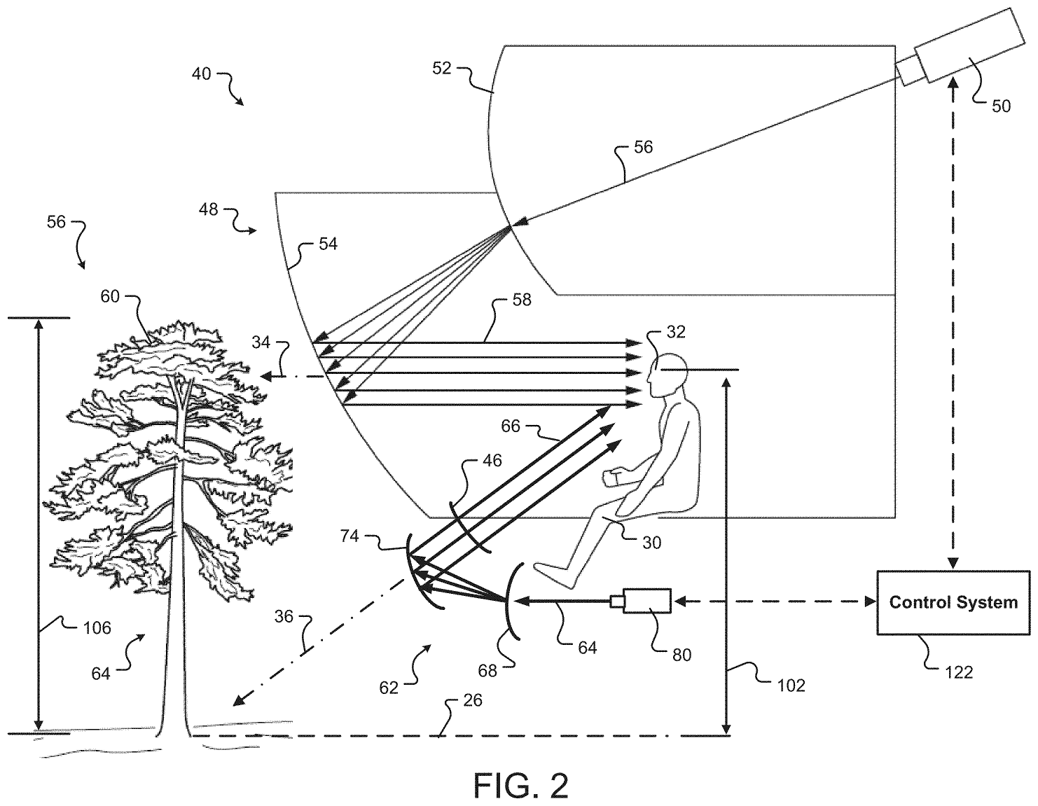

Referring now to FIGS. 2-6, a simulator 40 with a variable collimation display system 62 according to embodiments of the present disclosure is generally illustrated. The variable collimation display system 62 may be referred to as a variable display or a chin display herein. The variable display 62 is operable to adjust focal distances of images 64 displayed to a user 30 (e.g. a student) at a designated eye point 32 of the simulator 40.

Turning to FIG. 2, a simulator 40 with a variable collimation display system 62 according to embodiments of the present disclosure is generally illustrated. The simulator 40 may be an aircraft simulator configured to train the user 30 to operate an aircraft that includes a chin window 46. The aircraft may be a fixed wing aircraft, a helicopter, a tilt-rotor aircraft, or any other aircraft that has a chin window. However, it will be appreciated that the variable collimation display system 62 can be used with simulators that simulate operation of any type of vehicle. For example, simulators 40 for mobile equipment and vehicles of all sizes and types including cars, trucks, trains, tracked vehicles (such as tanks or construction vehicles), ships, and spacecraft may include a variable collimation display system 62 according to embodiments of the present disclosure. The variable collimation display system may also be used with games or other systems that may need to adjust or alter focal distances of images displayed to a user.

The simulator includes a primary display 48 that is configured to operate in coordination with the variable collimation display system 62. The primary display includes a projector 50 that projects an image 56 onto a screen 52. The image 56 is viewed by the user 30 as a reflection in a mirror array 54. The image 56 of the primary display 48 is visible to the user as collimated light rays 58 and seen at a distant focus. The image 56 may include an object 60 with a position simulated to be outside the simulated cockpit and which may be viewed by the user as indicated by a first arrow 34. In the example of FIG. 2, the object 60 is a tree.

The image 56 (and the object 60 displayed in the image) may be at an infinity focus, such as with a focal distance of greater than approximately 30 feet. Accordingly, the collimated light rays 58 of the image are substantially parallel to each other.

The variable collimation display system 62 is configured to project another image 64 through a chin window 46 of the simulator 40. The user 30 may view the image 64 by looking through the chin window 46 as generally indicated by a second arrow 36.

The chin window 46 is positioned between the designated eye point 32 where the user 30 will be positioned within the simulator 40 and a mirror 74 of the variable collimation display system 62. The chin window 46 is generally positioned at or near floor level of the simulator 40 and is typically used by the user 30 during simulations for take-off, landing, and/or hovering of the simulated aircraft. It will be appreciated that the variable collimation display system 62 may also be used during other simulated procedures.

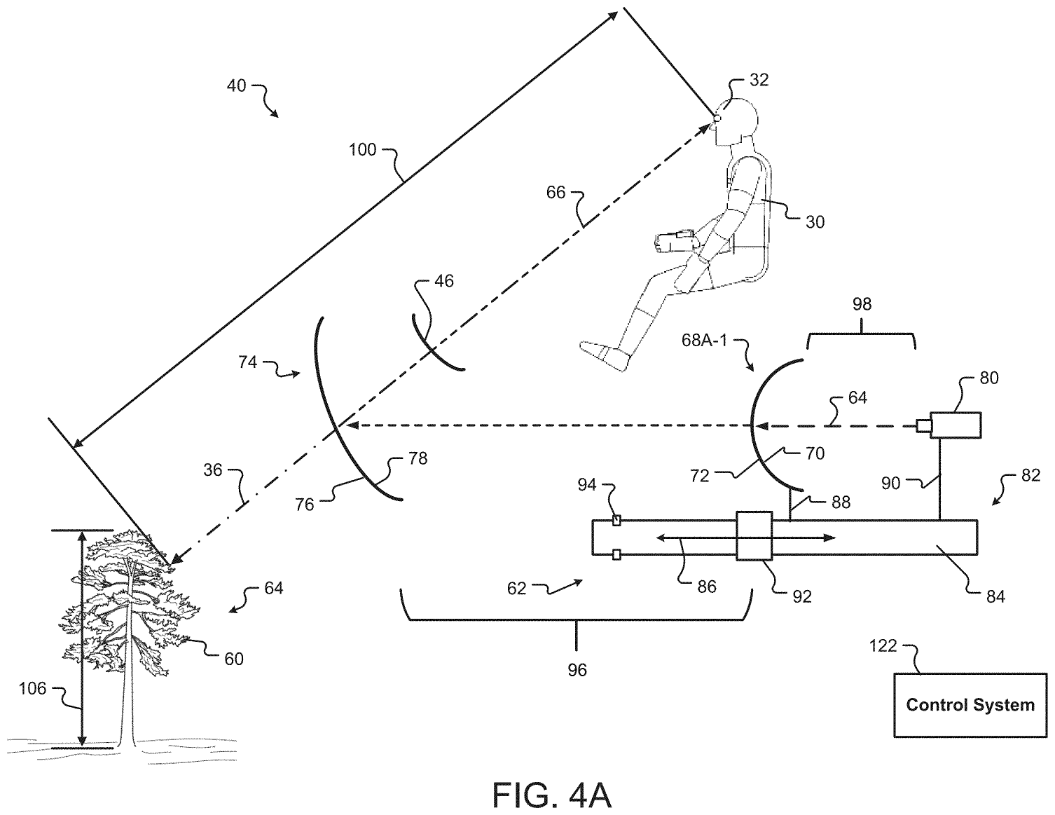

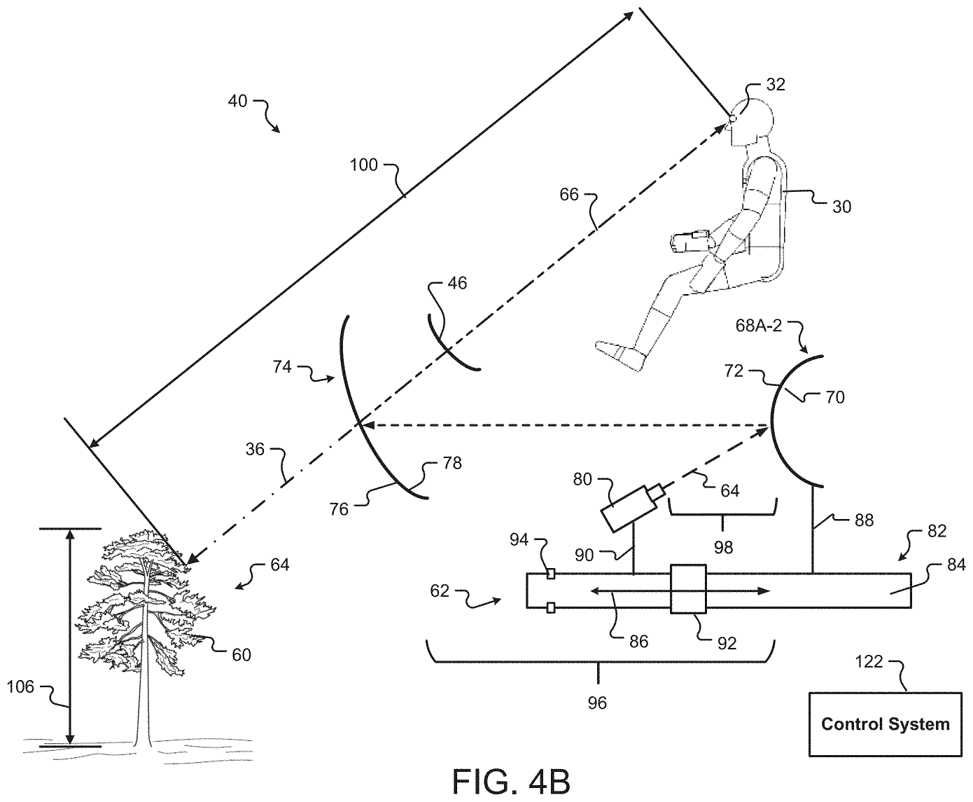

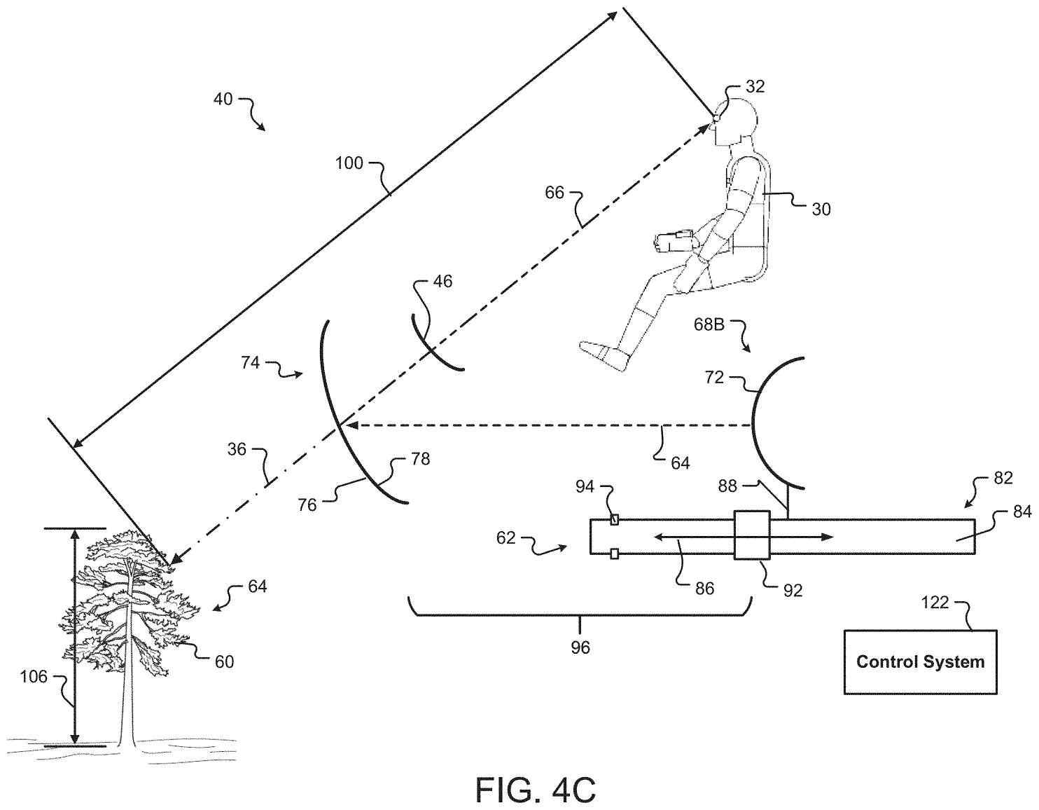

The variable collimation system generally includes the mirror 74 and a screen 68. In some embodiments the variable collimation display system 62 includes a projector 80 such as illustrated in FIG. 2. The projector 80 and the screen 68 may have different alignments in other embodiments as described herein such a generally illustrated in FIG. 4B. In addition, in some embodiments of the present disclosure (for example, as described in conjunction with FIG. 4C) the screen is self-illuminating such that the variable collimation system 62 does not include a separate projector 80. In use, the projector 80 (or the screen 68) projects the image 64 which is viewed by the user 30 as a reflection in the mirror 74.

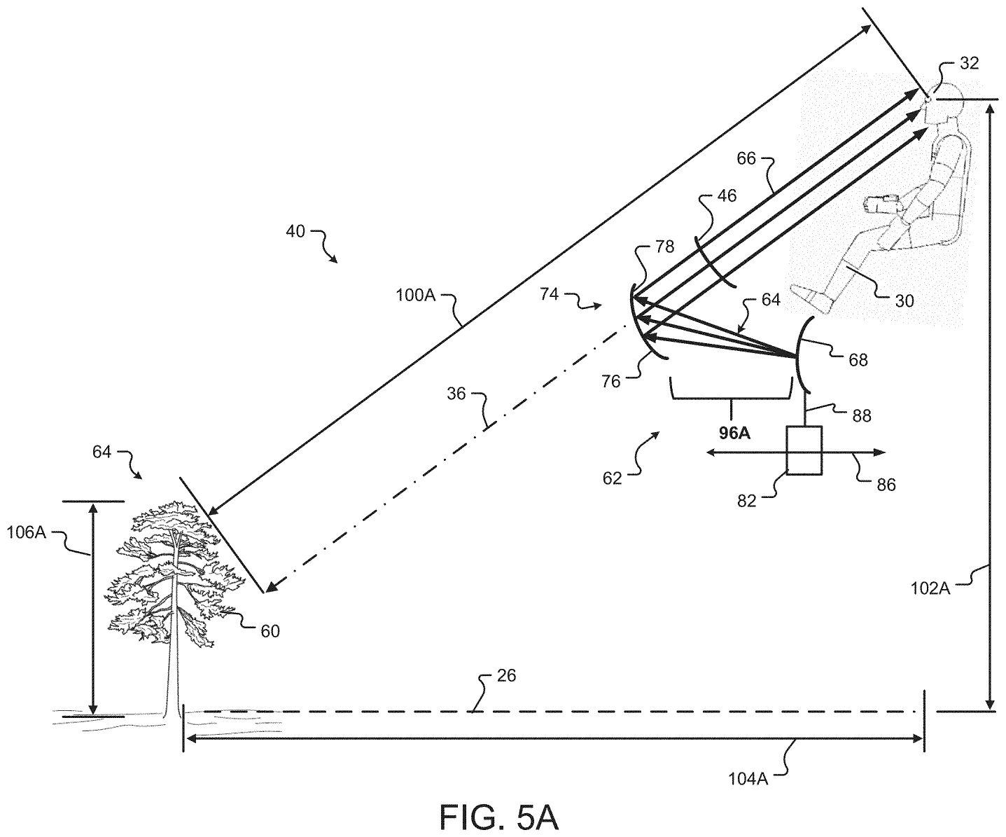

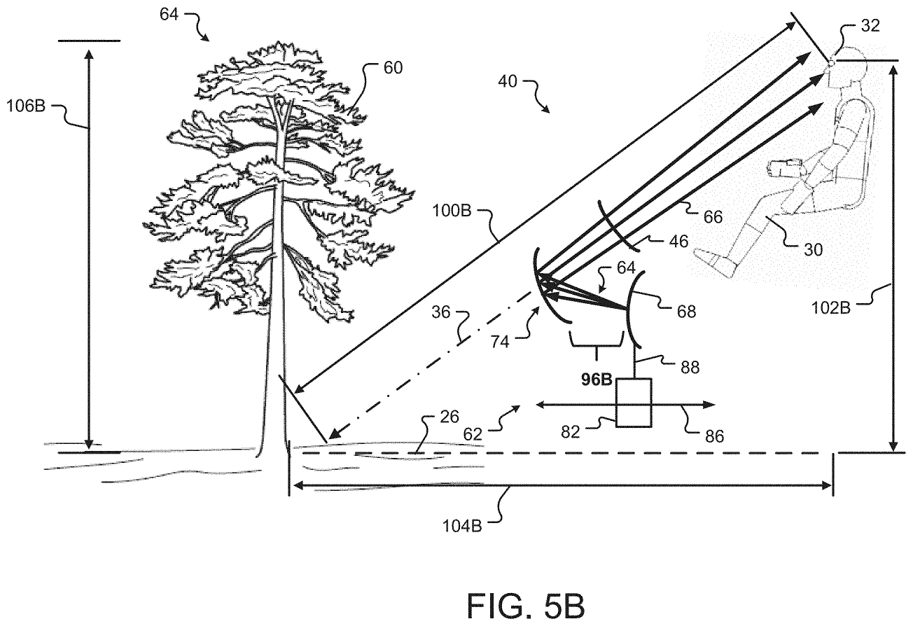

In all embodiments of the variable collimation display system 62, the image 64 will align with the image 56 of the primary display 48. Accordingly, as generally illustrated in FIG. 2, the tree 60 in the images 56, 64 of the primary display 48 and the variable collimation display system 62 will stay aligned with each other from the perspective of the user 30 at the designated eye point. Moreover, a control system 122 in communication with the primary display 48 and the variable collimation display system 62 can change the simulated size 106 of the object 60 in the images as the simulated height 102 above the ground 26 of the aircraft changes (as generally illustrated in FIGS. 5A, 5B.

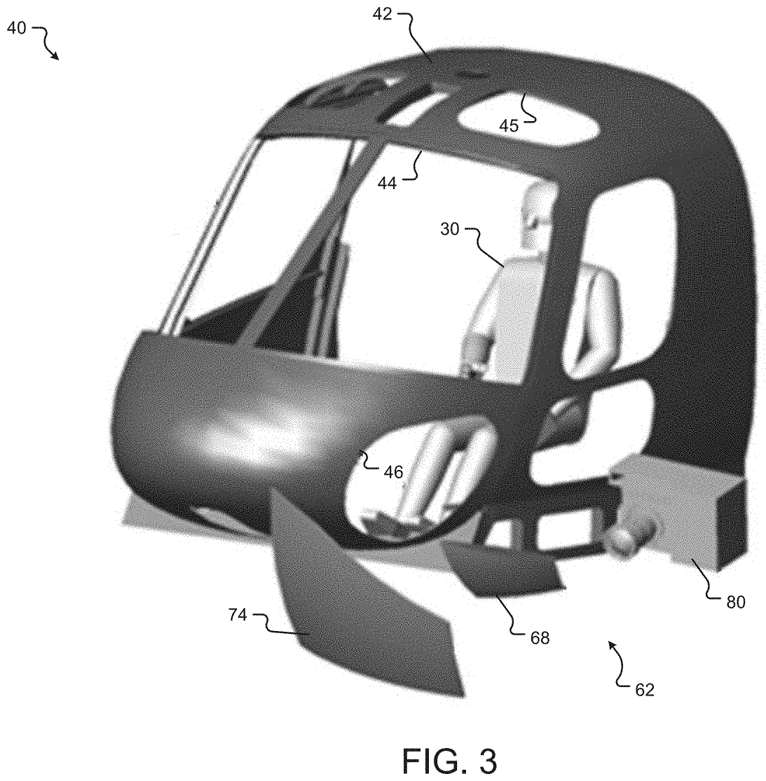

FIG. 3 generally illustrates the variable collimation display system 62 according to some embodiments relative to a cockpit 42 of a simulator 40. The cockpit 42 may include a window 44 associated with the primary display 48. The variable collimation display system 62 is positioned to display an image 64 through the chin window 46. Although only one variable collimation display system 62 is illustrated, the simulator 40 may have a second variable collimation display system associated with a second chin window on the other side of the cockpit 42.

In some embodiments, the cockpit 42 may include an upper window 45. Optionally, the simulator 40 may include a variable collimation display system associated with one or more upper windows 45. Further, a variable collimation display system could be associated with any window of the cockpit, such as a side window, or a lower side window.

Referring now to FIGS. 4A-4C, embodiments of a simulator 40 with the variable collimation display system 62 of the present disclosure are generally illustrated. In all embodiments, the variable collimation display system is configured and operable to adjust or alter a focal distance of an image 64 displayed to the user 30 based on a simulated or perceived distance 100 (also referred to the “slant distance” or the “line of sight distance”) between the designated eye point 32 of the user and a simulated environment or an object 60 outside of the simulated vehicle.

The variable collimation display system 62 comprises a screen 68, a mirror 74, and an adjustor 82. The screen 68 is configured and operable to display an image 64. The mirror 74 is configured and operable to reflect the image displayed by the screen 68 to the designated eye point 32. It will be appreciated that although the variable collimation display system is shown in use with a chin window 46, the variable collimation display system can be used for any display visible through any window of a simulator and in any simulated environment.

The focal distance of the variable collimation display system 62 is adjusted by the adjustor 82. The adjustor 82 is operable to alter a distance 96 between the screen 68 and the mirror 74. As the focal distance changes, a size or height 106 of the object 60 appearing in the image 64 displayed on the screen may be adjusted by a control system 122 of the simulator, as described herein. The control system 122 is in communication with one or more components of the variable collimation displays system, such as the adjustor 82 and a projector 80.

The mirror 74 has rear surface 76 and a front surface 78 opposite the rear surface. The front surface 78 of the mirror is oriented toward the chin window and toward a front surface 72 of the screen 68 and is adapted to reflect light from the screen to the designated eye point. In this manner, the user 30 views the image 64 in the reflective front surface 78 of the mirror 74.

The mirror 74 and its front surface 78 may be of any shape and size. For example, the mirror 74 may be curved or flat. In some embodiments, the front surface 78 of the mirror has a shape that includes at least a section of a circle, a sphere, a parabolic, an ellipsoid, a plane, a freeform, and combinations thereof. In some embodiments, the front surface 78 may be described as being generally concave.

The front surface 78 of the mirror has a shape configured to collimate light from the screen 68 when the screen is a predetermined distance from the mirror 74.

Optionally, the front surface 78 of the mirror is substantially rigid. Additionally, or alternatively, the front surface 78 of the mirror may have a shape that is adjustable.

In some embodiments, the mirror 74 may comprise a plurality of mirrors. In such embodiments, the plurality of mirrors may include a combination of curved and/or flat mirrors.

In at least one embodiment, the mirror 74 is stationary relative to the chin window 46 and the screen 68 is moveable by the adjustor 82. In such embodiments, the mirror 74 is at a fixed distance from the designated eye point 32.

The adjustor 82 is configured and operable to alter the distance 96 between the front surface 72 of the screen 68 and the front surface 78 of the mirror. Accordingly, the distance 96 is variable. The adjustor 82 may move the screen 68 in any manner known to one of skill in the art.

In some embodiments, the adjustor 82 comprises a platform 84 that is movable relative to the mirror 74. More specifically, the platform may move toward or away from the mirror 74 as generally indicated by arrow 86.

Optionally, in at least one embodiment, the adjustor 82 is configured to move the screen 68 along an optical centerline (or optical axis) of the mirror 74. However, in other embodiments, the adjustor 82 can move the screen 68 along a different axis relative to the mirror.

The screen 68 may be fixed to the platform 84. Accordingly, the screen 68 moves with the platform 84 toward or away from the mirror 74 as indicated by arrow 86. Any suitable means of fixing the screen to the platform known to those of skill in the art may be used with the variable display 62 of the present disclosure. In some embodiments, the screen 68 is fixed to the platform by a mount or a stand 88.

Optionally, the stand 88 is operable to alter the orientation of the screen 68 relative to one or more of the platform 84 and the mirror 74. In this manner, an orientation of the front surface 72 of the screen 68 may be altered as the platform 84 alters the distance 96 between the screen and the mirror. In some embodiments, the stand 88 can rotate the screen around a vertical axis of the stand. Additionally, or alternatively, the stand may pivot the screen relative to the vertical axis.

The adjustor 82 includes an actuator 92 configured to move the platform 84. The actuator 92 may move the platform 84 toward or away from the mirror in response to a signal from the control system 122. It will be appreciated that the adjustor 82 may be configured to move any component or any combination of components of the variable collimation display system 62.

The actuator may include any suitable means known to those of skill in the art that is operable to alter the position of the platform 84 relative to the mirror. In some embodiments, the actuator 92 comprises a motor. Additionally, or alternatively, the actuator may comprise a track, a rail, a wheel, a gear, a piston, a servo drive, a worm drive, a belt, a cable and the like. In some embodiments, the adjustor 82 may comprise a track on which the screen 68 is configured to move or slide to adjust the distance 96.

In some embodiments, the adjustor 82 comprises a motor for moving the screen 68. It will be appreciated that the motor may also be configured to move the mirror 74 and/or the projector 80.

In some embodiments, the adjustor 82 optionally includes a stop 94. The stop 94 is configured to prevent unintended or inadvertent contact of the screen 68 with the mirror 74. For example, the stop 94 is configured to maintain a predetermined minimum distance 96 between the screen 68 and the mirror 74. In this manner, the stop 94 can prevent the screen 68 from contacting the mirror 74.

The stop 94 may be associated with the platform 84. Alternatively, the stop may be associated with the actuator 92. Other means of preventing the screen from moving less than a predetermined distance 96 from the mirror may be used with the variable collimation display system 62 of the present disclosure.

Referring now to FIGS. 4A and 4B, in some embodiments, the variable collimation display system 62 also includes a projector 80 configured to project the image 64 onto a screen 68A. In some embodiments, the projector 80 has a lens with a fixed focal length. Alternatively, the projector 80 may include optics, such as one or more lens and/or a mirror, such that the focal length can be adjusted and/or to adjust the size of an object 60 in an image 64.

The projector 80 may be fixed to the platform 84. Accordingly, the projector 80 may move with the platform 84 as the platform adjusts the position of the screen 68A relative to the mirror 74. Any suitable means of fixing the projector to the platform known to those of skill in the art may be used. In some embodiments, the projector 80 is fixed to the platform by a mount 90.

In some embodiments, the projector 80 is positioned a fixed distance 98 from the screen 68A. Specifically, in some embodiments, the distance 98 between the projector and the screen does not change and is substantially constant. In these embodiments, the adjustor 82 is configured to move both the screens 68A-1, 68A-2 and the projectors 80 substantially simultaneously.

Alternatively, in at least one embodiment, the distance 98 between the projectors 80 and the screens 68A-1, 68A-2 may also be altered by the adjustor 82.

The screen 68A may have any shape. In some embodiments, the screen may be curved or flat. The rear surface 70 of the screen 68A may be concave and the opposite front surface 72 may be convex. In some embodiments, the screens 68A-1, 68A-2 and 68B have a shape that includes at least a section of a circle, a sphere, a parabolic, an ellipsoid, a plane, a freeform, and combinations thereof.

In embodiments where the variable collimation display system 62 includes the projector 80, the screen 68A may be a back projection screen 68A-1 (as illustrated in FIG. 4A) or a front projection screen 68A-2 (shown in FIG. 4B).

As shown in FIG. 4A, in embodiments where the screen 68A-1 is a back projection screen, the projector 80 is positioned to project an image 64 onto the rear surface 70 of the screen 68A-1. The image 64 is visible on the front surface 72 of the screen 68A-1 and is then reflected by the front surface 78 of the mirror.

In some embodiments, the screen 68A-1 is formed of a clear or substantially transparent material. For example, the screen 68A-1 may be an acrylic or may be a glass. Optionally, the screen 68A-1 is treated to diffuse light from the projector 80. In some embodiments the screen 68A-1 includes a diffusion coating or film. In some embodiments, a film or coating is applied to the convex front surface 72 to enable the image 64 to be focused onto the screen 68A-1.

In embodiments where the screen 68A-2 is a front projection screen, as shown in FIG. 4B, the projector 80 is positioned to project an image 64 onto the front surface 72 of the screen 68A-2. In some embodiments, the projector 80 may be positioned at least partially between the front surface 72 of the screen 68A-2 and the mirror 74.

The image 64 produced by the projector 80 is reflected from the front surface 72 onto the mirror 74. The screen 68A-2 may be formed of an opaque material. In some embodiments, the screen 68A-2 is formed of a glass, a plastic, a fiberglass, a metal or similar materials.

It will be understood by one skilled in the art that any arrangement of a projector 80, a screen 68, and a mirror 74 are within the scope of the present disclosure. In some embodiments, the variable collimation display system 62 can be used with a simulator 40 having screens 68 and mirrors 74 with different configurations and arrangements. For example, a curved screen 68 may be used with a flat mirror 74, a curved mirror 74 may be used with a flat screen 68, and/or a curved mirror 74 may be used with a curved screen 68. In one embodiment, the screen 68 and the mirror 74 are generally concave and curved in two or more dimensions.

Referring now to FIG. 4C, in other embodiments the variable collimation display system 62 does not include a projector 80. In these embodiments, the screen 68B is a self-illuminating screen and may include elements of the projector to project an image 64 from a front surface 72 of the screen 68B. Accordingly, the screen 68B projects the image from its front surface 72. The image 64 is then reflected by the front surface 78 of the mirror 74. The screen 68B may be any type of display operable to project an image such as, for example, a self-illuminating curved screen, a set of LED panels, a liquid-crystal display, an organic light-emitting diode display, a liquid crystal on silicon display, a light-emitting diode display, a quantum dot display, or a plasma display.

Referring now to FIGS. 5A and 5B, when the variable collimation display system is in use, an image 64 is projected on the screen 68 (whether self-projected or projected by the projector 80) and the image is viewed by the user 30 as a reflection in the mirror 74. The image 64 is visible to the user 30 as light rays 66 with a predetermined focus. The light rays 66 may be collimated (as shown in FIG. 5A) and appear at an infinity focal distance. Alternatively, by altering the position of the screen 68 relative to the mirror with adjustor 82, the light rays 66 of the image are visible to the user 30 at a fixed focal distance. As the screen 68 is moved closer to the mirror 74 and the distance 96 decreases, the light rays 66 diverge, and focus becomes less than infinity (such as generally illustrated in FIG. 5B).

The distance 96 from the screen 68 to the mirror 74 correlates to a focal distance for an image 64 visible to the user 30. As will be described in further detail, the distance 96 (or the focal distance) is determined based on a simulated distance 100 from the designated eye point 32 to an object 60 depicted in the image 64. The simulated distance is a perceived viewing distance. In other words, the simulated distance may be a distance between the designated eye point 32 and the object 60 as perceived by a user at the designated eye point if the object was physically present. The simulated distance 100 may also be referred to as the “slant distance”, the “perceived distance” or the “line of sight distance”.

When the screen 68 is in a first position (illustrated in FIG. 5A), the mirror 74 is a first distance 96A from the screen and the focal distance is at infinity. Accordingly, the light rays 66 reflected from the mirror are substantially parallel and the image 64 is collimated. The object 60 in the image 64 is a first distance 100A from the designated eye point and may be shown with a first simulated size or height 106A.

Referring to FIG. 5B, in a second position of the screen 68, the mirror 74 is a second distance 96B from the screen 68 and the focal distance is less than infinity. The second distance 96B is less than the first distance 96A. In the second position, the light rays 66 are slightly diverging as generally illustrated in FIG. 5B.

FIG. 5B also illustrates a second distance 100B between the designated eye point 32 and the object 60 in the image 64, the second distance 100B being less than the first distance 100A. Accordingly, because the designated eye point 32 is closer to the object 60 in FIG. 5B, the object 60 in the image 64 may be shown with a second simulated size or height 106B. The second height 106B is greater than the first height 106A illustrated in FIG. 5A.

In some embodiments, the screen 68 remains at the first position (that is, the first distance 96A) from the mirror 74 when the simulated distance 100 is above a predetermined threshold. In some embodiments, the predetermined threshold is about 30 feet. In other embodiments, the predetermined threshold may be less or greater than 30 feet.

The adjustor 82 may move the screen 68 to the second position (that is, the second distance 96B) from the mirror 74 when the simulated distance 100 meets the predetermined threshold. In at least one example, the predetermined threshold correlates to a height above terrain 102 of a simulated aircraft (such as, for example, a helicopter) in which the focal distance changes from infinity to less than infinity.

An example simulated scenario in which the predetermined threshold may be met includes a landing simulation. For example, for a simulated aircraft above the predetermined threshold, the focal distance of an image 64 viewed by the user 30 is infinity. Accordingly, the adjustor 82 may move the screen 68 to the first position at the first distance 96A from the mirror 74 as generally illustrated in FIG. 5A.

As the simulated aircraft descends toward a landing surface, the height 102B decreases and the simulated aircraft will reach the predetermined threshold. The focal distance of the image 64 viewed by the user 30 may be altered to be less than infinity by the adjustor 82 moving the screen 68 from the first position to the second position 96B and decreasing the first distance to the second distance 96B as generally illustrated in FIG. 5B. As the simulated aircraft continues to descend, the adjustor 82 may move the screen 68 to a third position closer to the mirror 74 to continue adjustment of the focal distance of the image 64.

During a take-off simulation, the opposite will occur. For example, during a take-off simulation, the adjustor 82 adjusts the distance 96 between the first distance 96A and the second distance 96B to cause the focal distance of an image 64 viewed by the user 30 to change between infinity and less than infinity or vice versa.

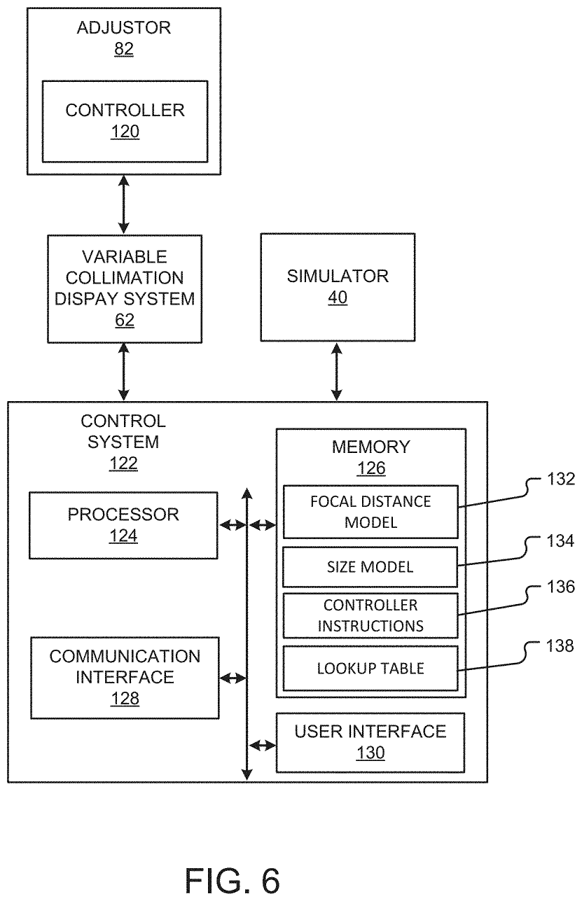

In one embodiment, as described with respect to FIG. 6, the adjustor 82 may be automatically controlled by a controller 120 to move the screen 68 to adjust the distance 96 between the screen 68 and the mirror 74. In another embodiment, the adjustor 82 may be manually controlled by the user or an operator via a control system 122.

Referring now to FIG. 6, the simulator 40 may include a control system 122 in communication with the variable collimation display system 62. Suitable control systems 122 are known to those of skill in the art. In some embodiments, the control system 122 is a personal computer, such as, but not limited to, a personal computer running the MS Windows operating system, the Mac OS, Linux or any other known operating system. Optionally, the control system can be a smart phone, a tablet computer, a laptop computer, and similar computing devices. In other embodiments, the control system is a data processing system which includes one or more of, but is not limited to: an input device (e.g. a keyboard, mouse, or touch-screen); an output device (e.g. a display, a speaker); a graphics card; a communication device (e.g. an Ethernet card or wireless communication device); permanent memory (such as a hard drive); temporary memory (for example, random access memory); computer instructions stored in the permanent memory and/or the temporary memory; and a processor.

In some embodiments, the control system 122 is integrated or embedded into an image generator associated with the simulator 40. The control system 122 may also be integrated or embedded in a host computer of the simulator. Additionally, or alternatively, the control system 122 may be a virtual machine running on (or operated by) the computer system of the simulator. In still other embodiments, the control system 122 is associated with a computer system in communication with an image generator or a host computer system of the simulator 40.

The control system 122 according to embodiments of the present disclosure may comprise a processor 124, a memory 126, a communication interface 128, and a user interface 130. The control system 122 in some embodiments may have more components or fewer components than illustrated in FIG. 6. The control system 122 may be any suitable computer known to one of skill in the art.

The processor 124 of the control system 122 may be any processor known to one of skill in the art, including a processor described herein or any similar processor. The processor 124 may be configured to execute instructions stored in the memory 126, which instructions may cause the processor 124 to carry out one or more computing steps utilizing or based on data received from the variable collimation display system 62.

The memory 126 may be or comprise RAM, DRAM, SDRAM, other solid-state memory, any memory described herein, or any other tangible, non-transitory memory for storing computer-readable data and/or instructions. The memory 126 may store information or data useful for completing any operation described herein, including steps or operations of the methods 140 and/or 160 described herein. The memory 126 may store, for example, a focal distance model 132, a size model 134, a simulation software, an image engine or image generating software, and/or controller instructions 136. Such instructions may, in some embodiments, be organized into one or more applications, modules, packages, layers, or engines. The instructions may cause the processor 124 to manipulate data stored in the memory 126 and/or received from the variable collimation display system 62.

In some embodiments, the memory 126 may include a lookup table 138. Optionally, in at least one embodiment, the lookup table 138 includes predefined distances 96 between the mirror 74 and the screen 68 for a plurality of predefined situations. In some embodiments, the lookup table includes distances 96 based on a simulated height 102 of a simulated aircraft. Additionally, or alternatively, the lookup table may include distances 96 for the screen to be spaced from the mirror based on the slant range or the simulated distance 100 from the designated eye point 32 to an object 60 in an image 64.

For example, the lookup table 138 may indicate that the adjustor 82 should move the screen 68 to a first position with a first distance 96A (such as generally illustrated in FIG. 5A) when the simulated height 102A is above a predetermined amount. The lookup table 138 may then include values to decrease the distance 96 when the simulated height 102 is less than the predetermined amount. For example, when the simulated height 102 is 95% of the predetermined amount, the lookup table may include a second distance 96 expressed as a percentage of the first distance, such as 95% of the first distance. Alternatively, the second distance 96 may be expressed as a distance (in inches or centimeters) to be subtracted from the first distance. Continuing this example, as the simulated height 102 continues to decrease, the lookup table may include values to decrease the distance 96 between the screen and the mirror until a minimum distance 96 is reached, such as when the simulated aircraft lands.

In some embodiments, the lookup table 138 may define distances 96 between the screen 68 and the mirror 74 based on the simulated distance 100 from the designated eye point 32 to an object 60 in an image 64. For example, if the simulated distance 100 is greater than a predetermined amount, for example 18 feet, the lookup table may indicate that the screen should be a first distance 96 from the mirror. As the simulated aircraft more closely approaches the object, the lookup table may include values to decrease the distance 96 such that the screen progressively moves closer to the mirror.

Including predetermined values for the distances 96 based on one or more of the simulated height 102 and the simulated distance 100 to an object 60 is beneficial to support different flight operations. For example, during a landing or take-off simulation, it may be beneficial to determine the distance 96 between the screen and the mirror based on the simulated height 102 of the aircraft. However, in some simulations, such as a high hover next to an object 60, the simulated height 102 may be above a predetermined threshold such that the screen 68 would be spaced from the mirror 74 by a distance 96 sufficient that the image 64 of the variable collimation display system would be at infinity focus. But the simulated aircraft may be very close to the object 60 such that the simulated distance 100 is less than the predetermined amount. Accordingly, the screen should be moved toward the mirror to decrease the distance 96 and change the focal length of the object 60 in the image 64.

The control system 122 may also comprise a communication interface 128. The communication interface 128 may be used for receiving information from an external source (such as the variable collimation display system 62), and/or for transmitting instructions, data, or other information to an external system or device (e.g., the adjustor 82, the projector 80 (or the screen 68B) and/or variable collimation display system, and the projector 50 of the primary display 48). The communication interface 128 may comprise one or more wired interfaces (e.g., a USB port, an ethernet port, a Firewire port) and/or one or more wireless interfaces (configured, for example, to transmit information via one or more wireless communication protocols such as 802.11a/b/g/n, Bluetooth, NFC, ZigBee, and so forth). In some embodiments, the communication interface 128 may be useful for enabling the control system 122 to communicate with one or more other processors 124 or other control systems 122, whether to reduce the time needed to accomplish a computing-intensive task or for any other reason.

The control system 122 may also comprise one or more user interfaces 130. The user interface 130 may be or comprise a touchpad (for example, of a laptop computer), keyboard, mouse, trackball, monitor, television, touchscreen, joystick, switch, button, and/or any other device for receiving information from a user and/or for providing information to a user. The user interface 130 may be used, for example, to receive a user selection or other user input regarding the focal distance model 132; to receive a user selection or other user input regarding a simulation executed by the simulator; to receive user input useful in connection with the controller instructions 136; and/or to display the instructions 136. In some embodiments, the user interface 130 may be useful to allow a user or operator to modify the instructions 136, the adjustor 82 (such as to change a position of the screen 68), or other information displayed, although it will be appreciated that each of the preceding inputs may be generated automatically by the control system 122 (e.g., by the processor 124 or another component of the control system 122) or received by the control system 122 from a source external to the control system 122. In some embodiments, user input such as that described above may be optional or not needed for operation of the systems, devices, and methods described herein.

Although the user interface 130 is shown as part of the control system 122, in some embodiments, the control system 122 may utilize a user interface 130 that is housed separately from one or more remaining components of the control system 122. In some embodiments, the user interface 130 may be located proximate one or more other components of the control system 122, while in other embodiments, the user interface 130 may be located remotely from one or more other components of the control system 122.

Optionally, as illustrated in FIG. 6, the adjustor 82 may include a controller 120. The controller 120 is operable to control the adjustor 82 to cause the adjustor 82 to move the screen 68 to alter the distance 96 between the screen 68 and the mirror 74. In other embodiments, the adjustor does not include the controller 120.

The controller 120 may be an electronic, a mechanical, or an electro-mechanical controller. The controller 120 may comprise or may be any processor described herein. The controller 120 may comprise a memory storing instructions for executing any of the functions or methods described herein as being carried out by the controller 120. In some embodiments, the controller 120 may be configured to simply convert signals received from the control system 122 (e.g., via a communication interface 128) into commands for operating the adjustor 82. In other embodiments, the controller 120 may be configured to process and/or convert signals received from the adjustor 82. Further, the controller 120 may receive signals from one or more sources (e.g., the adjustor 82) and may output signals to one or more sources.

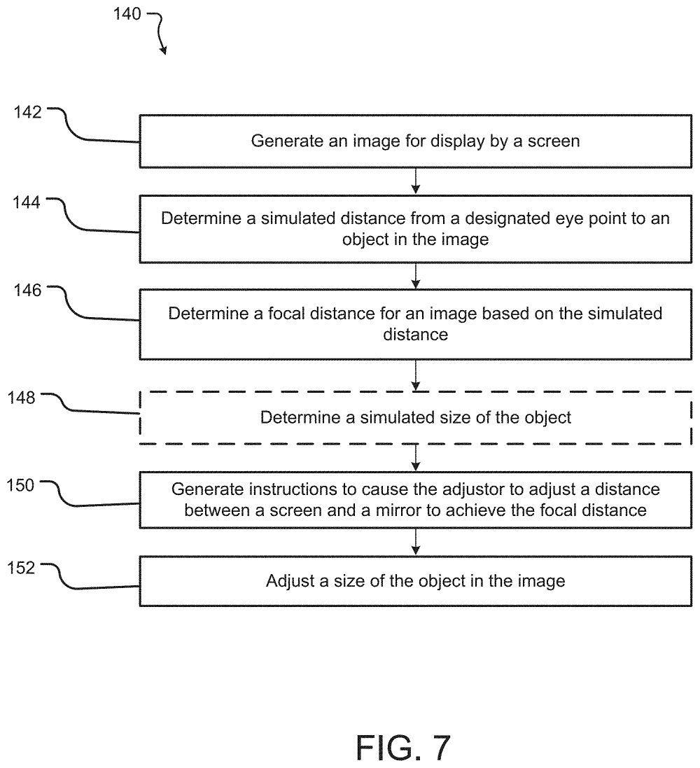

Turning now to FIG. 7, a method 140 for adjusting focal distances of images 64 displayed to a user 30 at a designated eye point 32 of a simulator 40 is provided. The method 140 may be performed using, for example, the components described above with respect to FIGS. 2-6.

The method 140 comprises generating an image 64 for display by a screen 68 of the variable collimation display system 62 in operation 142. The image depicts an environment outside of a simulated vehicle (for example, an aircraft) and may include an object 60, such as a tree. The image 64 is transmitted to the projector 80 or the screen 68B of the variable collimation display system.

In some embodiments, the projector 80 may project the image 64 on the front surface 72 of the screen 68A-2 (for a front projection screen) or on the rear surface 70 of the screen 68A-1 (for a back projection screen). In other embodiments where the screen 68B is a self-illuminating screen, the image may be projected by the screen 68B itself.

The image may be generated by the control system 122. For example, the image 64 may be generated as part of a simulation software stored in memory 126. In some embodiments, the image 64 is created by an image generator software stored in the memory 126.

In some embodiments, the image 64 is received by the communication interface 128 from a separate control system, such as a control system that controls the simulator 40 and which is configured to generate the image.

The method 140 also comprises operation 144 which includes determining a simulated distance 100 from the designated eye point 32 to the object 60 in the image 64. The simulated distance may be a perceived viewing distance. In other words, the simulated distance may be a distance between the designated eye point 32 and the object 60 as perceived by a user 30 at the designated eye point if the object was physically present. In some embodiments, the simulated distance may be (or may be related to) a simulated height 102 above terrain of a simulated aircraft, for example. The height above terrain 102 may be a distance between the simulated aircraft and a ground surface 26.

In some embodiments, the simulated distance 100 is determined using the Pythagorean theorem and inputting the height 102 of the simulated aircraft at the designated eye point 32 and the horizontal distance 104 to the object 60. In some embodiments, the simulated distance may be determined using method 160 described herein.

The method 140 also comprises operation 146 which includes determining a focal distance for the image 64 based on the simulated distance 100 between the designated eye point 32 and the object 60 in the image. In some embodiments, determining the focal distance for the image comprises using the focal distance model 132 stored in memory 126 of the control system 122. In such embodiments, the processor 124 may input the simulated distance 100 to the focal distance model 132, execute the focal distance model 132, and receive the focal distance as an output from the focal distance model 132. In some embodiments, the focal distance model 132 may be trained using, for example, historical distances and/or simulated distances obtained from a simulation. Additionally, or alternatively, operation 146 may comprise retrieving the focal distance from a lookup table 138.

Method 140 may include optional operation 148 which comprises determining a simulated size 106 of the object 60 for display in the image 64. In some embodiments, the simulator 40 is configured to determine the simulated size 106 of the object. More specifically, the simulator 40 may include a control system which executes instructions to determine the simulated size of the object 60. The simulator control system may then send a signal to the communication interface 128 with the simulated size. The control system 122 can then send an instruction to the projector 80 (or the self-illuminated screen 68B) to project the image 64.

In some embodiments, the control system 122 inputs the simulated distance 100 to a size model 134 stored in memory 126. The size model then outputs the simulated size 106 to the control system 122 and its processor 124. Optionally, the size model 134 may be trained using, for example, historical distances and/or simulated distances obtained from a simulation.

The method 140 may also comprise generating instructions to cause the adjustor 82 to alter the distance 96 between the screen 68 and the mirror 74 to achieve the focal distance in operation 150. Optionally, operation 150 comprises retrieving the distance 96 from the lookup table 138 based on one or more of the height 102 above terrain, the horizontal distance 104 to an object, and the simulated distance 100 to the object in the image.

In some embodiments, the instructions are transmitted to the controller 120 to cause the adjustor 82 to adjust the distance 96. In embodiments where the adjustor 82 comprises an actuator 92, the controller 120 may control the actuator to move the screen 68 with respect to the mirror 74 as described herein.

The method 140 may also comprise operation 152 in which a size 106 of the object 60 in the image 64 is adjusted. The size of the object 60 in the image 64 may be adjusted based on the simulated size determined in operation 148. The size 106 of the object is adjusted to accommodate the adjustment to the distance 96 between the screen 68 and the mirror 74. The size of the object is also adjusted such that the object is visible as it would appear as a physical object at the focal distance. In other words, the size 106 of the object is adjusted to match a perceived view of the object if the object was physically viewable by the user 30.

It will be appreciated that the method 140 may include more or less steps than described above. One or more operations of method 140 may loop or be repeated as necessary such that the focal distance of images 64 displayed to the user 30 and the size 106 of the object 60 visible in the images are continuously updated in real-time. The focal distance as perceived by the user 30 is adjusted to match the perceived distance 100 to the object 60 being displayed in the image 64. As described herein, this is accomplished by changing the distance 96 between the mirror 74 in which the user 30 views the object 60, and the screen 68 displaying the image 64 created by the control system 122. By manipulating the mirror/screen distance 96, the light rays reflecting from the mirror 74 can be adjusted from collimated (parallel light rays), representing infinity focus or far away objects (as illustrated in FIG. 5A), to gradually more and more diverging rays representing shorter focal distances as the simulated aircraft moves closer to objects and/or the ground (as illustrated in FIG. 5B). By adjusting the focal distance of the images in real-time, the environment as viewed by the user appears to be more accurate, particularly during take-off and/or landing procedures.

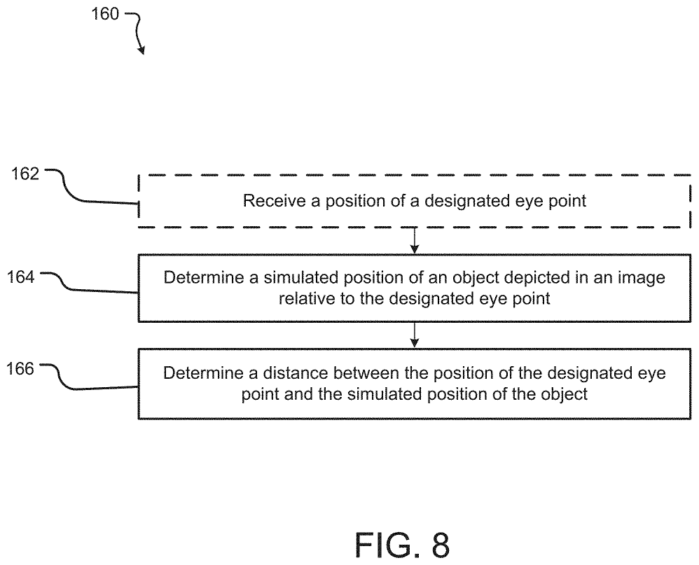

Turning now to FIG. 8, a method 160 for determining the simulated distance 100 is provided. The method 160 may be performed using, for example, the systems and components described above with respect to FIGS. 2-7. In some embodiments, method 160 is performed before method 140. Additionally, or alternatively, method 160 may be performed during method 140. For example, method 160 may be performed prior to operation 146. Method 140 may be paused for method 160 to be performed, then method 140 may be resumed upon completion of method 160.

Optional operation 162 of method 160 comprises receiving a position of the designated eye point 32. The position of the designated eye point 32 may be received as an input from a user via the user interface 130 in some embodiments. In other embodiments, the position of the designated eye point 32 may be determined by a sensor positioned near or at the designated eye point 32. For example, the user may wear a headset having a sensor configured to send sensor data comprising a position of the sensor to the control system 122. Additionally, or alternatively, the position of the designated eye point 32 may be retrieved from memory 126 of the control system 122.

Method 160 also comprises determining a simulated position of an object 60 depicted in an image 64 relative to the designated eye point 32 in operation 164. In some embodiments, determining the simulated position of the object may comprise determining a distance between the position of the designated eye point 32 and the mirror 74. Additionally, or alternatively, a position of the object (or the simulated distance 100 to the object) may be received from the simulator 40, or as an output of a simulation software or from an image generator creating images for the simulator.

The method 160 may also include operation 166 which comprises determining a distance between the position of the designated eye point 32 and the simulated position of the object 60 to yield the simulated distance 100. The simulated position of the object is received from operation 164. In some embodiments, determining the distance comprises subtracting the x and/or y coordinate of the designated eye point 32 from the x and/or y coordinate of the simulated position of the object 60.

It will be appreciated that the method 160 may include more or less steps than described above.

The methods and systems described herein adjust a focal distance of an image displayed to a user at a designated eye point of a simulator using a mirror, a screen, an adjustor, and a control system to adjust the focal distance in real-time. The methods and systems advantageously adjust the focal distance of the image as the simulator simulates approaching or distancing the designated eye point to the image. Such focal distance adjusting improves the realism of the image to the user, in particular during a landing or a take-off simulation, thereby improving the simulation experience.

Another benefit of the methods and systems described herein is that an object 60 displayed in an image 64 of the variable collimation display system 62 will align with (and be of a corresponding size to) an object 60 shown in an image 56 produced by a primary display 48. This improves realism of simulations run in the simulator.

The variable collimation display system 62 of embodiments of the present disclosure provides further benefits in that it is compatible with Night Vision Goggles (NVGs) in situations where NVGs are in-focus in real aircraft. More specifically, as will be appreciated by one of skill in the art, the NVGs used in a simulator 40 are focused at or near infinity to match the focus of the primary “Out the Window” display 48, as they would be in an actual aircraft which the simulator 40 replicates. This level of realism is important since it means the instrument panel within the simulator cockpit 42 is out of focus in the NVGs, as the instrument panel would be in the real aircraft. To see the instrument panel within the simulator, the pilot 30 must “train like they fly” and learn to pick up instrument cues by glancing below the night vision goggles.

A variable collimation display system 62 associated with a chin window 46 of a simulator 40 of the present disclosure can produce near-infinity focus in some simulated flying situations (such as in a high hover). Therefore, when the screen 68 of the variable collimation display system is in the first position a first distance 96A from the mirror 74 (illustrated in FIG. 5A) to produce near-infinity focus, the image 64 produced by the variable collimation display system 62 will be compatible with NVGs (or will be in focus when viewed through the NVGs). This is similar to a pilot viewing an object through a chin window of a real aircraft (or helicopter) while in a high hover.

As a real aircraft descends from high hover, objects will come nearer and become out of focus in the NVGs. A pilot must glance below the NVGs to see objects through a chin window as the aircraft descends.

The variable collimation display system 62 can replicate this by moving the screen 68 to a second position that is a second distance 96B from the mirror 74 (as shown in FIG. 5B) in which the image 64 is at less than infinity focus. The pilot user 30 would then need to look under the night vision goggles to pick up ground cues through the chin window 46 of the simulator (as they would in the real aircraft). In this manner, the variable collimation display system 62 of the present disclosure builds positive habits and improves the realism of the simulator 40.

As may be appreciated based on the foregoing disclosure, the present disclosure encompasses methods with fewer than all of the steps identified in FIGS. 7 and 8 (and the corresponding description of the methods 140 and 160), as well as methods that include additional steps beyond those identified in FIGS. 7 and 8 (and the corresponding description of the methods 140 and 160). While a general order of the methods 140 and 160 are shown in FIGS. 7-8, it will be understood by one of skill in the art that the steps of the methods can be arranged and performed differently than those shown in FIGS. 7-8. Further, although the steps of the methods may be described sequentially, many of the steps may in fact be performed in parallel or concurrently.

While various embodiments of the system have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

Several variations and modifications of the disclosure can be used. It would be possible to provide for some features of the disclosure without providing others.

The features of the various embodiments described herein are not intended to be mutually exclusive. Instead, features and aspects of one embodiment may be combined with features or aspects of another embodiment. Additionally, the description of a specific element with respect to one embodiment may apply to the use of that specific element in another embodiment, regardless of whether the description is repeated in connection with the use of the specific element in the other embodiment.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

One aspect of the disclosure comprises any one or more of the aspects/embodiments as substantially disclosed herein.

Another aspect of the disclosure is any one or more of the aspects/embodiments as substantially disclosed herein optionally in combination with any one or more other aspects/embodiments as substantially disclosed herein.

It is another aspect of the present disclosure to provide one or more means adapted to perform any one or more of the above aspects/embodiments as substantially disclosed herein.

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

To provide additional background, context, and to further satisfy the written description requirements of 35 U.S.C. § 112, the following references are incorporated by reference herein in their entireties: U.S. Pat. Nos. 9,191,659; 10,942,360; and Canadian Patent Publication No. 3,113,582.

What is claimed is:

1. A system for adjusting a focal distance of an image displayed to a user at a designated eye point, comprising:
a screen configured to display the image depicting an object;
a mirror configured to reflect the image displayed by the screen to the designated eye point, the mirror spaced from the screen by a distance that is variable; and
an adjustor configured to move the screen to adjust the distance between the screen and the mirror.

2. The system of claim 1, further comprising a control system in communication with the adjustor, the control system configured to:
determine a focal distance for the image based on a simulated distance between the designated eye point and the object in the image;
determine a simulated size of the object based on the simulated distance;
generate instructions to cause the adjustor to adjust the distance between the screen and the mirror to achieve the focal distance; and
adjust a size of the object in the image based on the determined simulated size.

3. The system of claim 2, wherein the control system is further configured to generate the image

4. The system of claim 1, wherein the screen is at least one of a liquid-crystal display, an organic light-emitting diode display, a liquid crystal on silicon display, a light-emitting diode display, a quantum dot display, and a plasma display.

5. The system of claim 1, further comprising a projector configured to project the image onto the screen, wherein the screen is one of a front projection screen and a back projection screen.

6. The system of claim 5, wherein the projector is a fixed distance from the screen, and wherein the adjustor is configured to move the screen and the projector.

7. The system of claim 1, wherein the adjustor comprises a motor for moving the screen to adjust the distance.

8. The system of claim 7, wherein the mirror is stationary and the screen is interconnected to a platform of the adjustor, and wherein the platform is configured to move to adjust the distance between the screen and the mirror.

9. The system of claim 8, wherein the adjustor comprises a stop to prevent the screen from contacting the mirror.

10. The system of claim 1, wherein the distance from the screen to the mirror correlates to the focal distance, wherein in a first position the screen is a first distance from the mirror and the focal distance is at infinity, and wherein in a second position the screen is a second distance from the mirror and the focal distance is less than infinity, the first distance being greater than the second distance.

11. The system of claim 10, wherein in the first position, light rays reflected from the mirror are substantially parallel.

12. The system of claim 1, wherein the system is associated with a simulator configured to simulate an aircraft, wherein the simulator includes a chin window positioned between the designated eye point and the mirror, and wherein the image displayed by the screen is visible to the user through the chin window.

13. A control system for a simulator for adjusting a focal distance of an image at a designated eye point of the simulator, comprising:
a processor; and
a memory storing instructions for execution by the processor that, when executed, cause the processor to:
generate the image for display by a screen, wherein the screen is oriented such that the image is reflected by a mirror, through a chin window of the simulator and to the designated eye point;
determine a simulated distance from the designated eye point to an object in the image;
determine a focal distance for the image based on the simulated distance;
determine a simulated size of the object based on the simulated distance;
generate an instruction to cause an adjustor to alter a distance between the screen and the mirror to achieve the focal distance; and
adjust a size of the object in the image based on the simulated size.

14. The control system of claim 13, wherein determining the simulated distance comprises one or more of:
receiving a position of the designated eye point;
determining a simulated position of the object relative to the designated eye point; and
determining a distance between the position of the designated eye point and the simulated position of the object.

15. The control system of claim 13, wherein the distance between the screen and the mirror correlates to the focal distance, and wherein the memory further comprises an instruction which causes the processor to:
move the screen to a first position that is a first distance from the mirror such that the focal distance is at infinity when the simulated distance is above a predetermined threshold.

16. The control system of claim 15, wherein the memory further comprises an instruction which causes the processor to:
move the screen to a second position that is a second distance from the mirror such that the focal distance is less than infinity when the simulated distance is below the predetermined threshold, wherein the first distance is greater than the second distance.

17. The control system of claim 15, wherein the predetermined threshold is about thirty feet.

18. A method for adjusting a focal distance of an image at a designated eye point, comprising:
generating an image for display by a screen, wherein the screen is oriented such that the image is reflected by a mirror to the designated eye point;
determining a simulated distance between the designated eye point and a simulated position of an object in the image;
determining a focal distance for the image based on the simulated distance;
determining a simulated size of the object based on the simulated distance;
generating an instruction to cause an adjustor to alter a distance between the screen and the mirror to achieve the focal distance; and
adjusting a size of the object in the image based on the simulated size.

19. The method of claim 18, further comprising:
moving the screen away from the mirror to a first position that is a first distance from the mirror such that the focal distance is at infinity when the simulated distance is above a predetermined threshold; and
moving the screen toward the mirror to a second position that is a second distance from the mirror such that the focal distance is less than infinity when the simulated distance is below the predetermined threshold, wherein the first distance is greater than the second distance.

20. A flight simulator for training a student to operate an aircraft, comprising:
a primary display system to simulate a view out of a window of the aircraft, comprising:
a projector;
a first screen, wherein the projector is operable to generate a first image that is displayed on the first screen; and
a mirror array to reflect the first image to a designated eye point of the simulator; and
a variable collimation display system to simulate a second view outside the aircraft through a chin window in a cabin of the simulator, the chin window positioned near a floor of the cabin, the variable collimation display comprising:
a second screen to display a second image;
a mirror to reflect the second image from the second screen through the chin window and to the designated eye point; and
an adjustor configured to move the second screen relative to the mirror, wherein when the second screen is a first distance from the mirror the second image is at infinity focus, and wherein when the second screen is a second distance from the mirror the second image has a fixed focal distance that is less than infinity, the second distance being less than the first distance.

21. The flight simulator of claim 20, wherein the mirror is a fixed distance from the designated eye point.
